(19) United States
(12) Patent Application Publication
(10) Pub. No.: US 2009/0188017 A1
(43) Pub. Date: Jul. 30, 2009

(54) SENSOR EQUIPPED FLAME RETARDANT CLOTHING

(75) Inventor: Jens Peter Kruse, Oelgod (DK)

Correspondence Address: VEDDER PRICE P.C., 222 N. LASALLE STREET, CHICAGO, IL, 60601, US

(73) Assignee: VIKING LIFE-SAVING EQUIPMENT A/S, EsbjergV (DK)

(21) Appl. No.: 12/022,858

(22) Filed: Jan. 30, 2008

(51) Int. Cl. A62B 17/00; A41D 3/02; G08B 17/00; G08B 23/00

(52) U.S. Cl. 2/81; 2/97; 2/93; 340/584; 340/693.5

(57) ABSTRACT

A fire-fighter turnout coat having an outer flame retardant shell with exterior and interior sides, the shell layer having a dual layer of first and second materials woven together in a manner which allows the formation of void spaces between the first and second materials when the turnout coat is exposed to increasing heat, the first material generally having a polyparaphenylene isophthalamide meta-aramid polymer and the second material generally having a para-aramid polymer; a second inner thermal insulating layer having an interior side and comprising a woven or nonwoven material; a moisture barrier layer positioned between the outer shell and the inner insulating layer; and a thermal detector system having a first heat sensor positioned on the shell exterior side, the first sensor having a thermistor and a thermocouple, a second heat sensor positioned on the thermal layer interior side and having a thermistor, a first display positioned adjacent the first sensor on the shell layer exterior side, a second display positioned remotely from the first sensor on the shell layer exterior side, and a power supply, wherein the first and second sensors and the first and second displays are electrically interconnected with the power supply to communicate temperature change by light emission from the first and second displays, wherein the electrical interconnection is conductive textile ribbon.

### FIELD OF THE INVENTION

The invention relates generally to electronic thermal sensors which may be used in clothing that is subjected to environmental stresses such as open flame and elevated temperature. More specifically, the invention relates to clothing such as, for example, turnout gear worn by fire-fighters which is capable of monitoring and reporting increasing temperature.

### BACKGROUND OF THE INVENTION

Intelligent clothing, especially in hazardous environments can often mean the difference between life and death. Environmental extremes such as extremes in temperature, and exposure to elemental hazards like liquids, gases and solids that can detrimentally affect ambient conditions all must be considered.

Whether considering applications such as undersea or stellar exploration or the more mundane aspects of controlling natural disasters, protective clothing is a first priority. One application which occurs routinely throughout the world is fire protection. Fire protection or fire-fighting, as it is generically regarded, has historically been undertaken with an assortment of equipment that has evolved over time to become more technologically sophisticated.

Fire-fighters have tended to wear an assortment of equipment that serves at least two functions, protection from physical harm and protection from heat. Fire gear has traditionally emphasized the use of helmets, protective boots, as well as multi-layer pants and jackets. Protective pants and jackets used by fire-fighters are commonly known as “″turn out” gear.

Turn out gear may take many styles, forms and fashions. Boots and bunker pants tend to work together to provide protection over the fire-fighter's lower extremities, seat and legs. Often times, bunker pants can be substituted for high boots and a long bunker jacket. At the same time, a bunker jacket is generally worn by the fire-fighter to protect his upper extremities.

The more traditional piece of turnout gear is the fire-fighter's jacket or bunker coat. A bunker coat is a system which generally includes one or more layers designed to insulate the fire-fighter from physical harm and temperature extreme while absorbing moisture. Traditionally, the outer layer of the coat protects against physical harm such as open flame while the inner layer of the coat provides thermal insulation. Moisture insulation may also be provided by added layers.

Fire-fighting is characterized by extreme stress caused by any number of factors. Periods of extreme physical exertion, for example, carrying heavy rescue equipment while performing physically demanding tasks, exposure to critical temperatures and hazardous substances all contribute to this stress. While protective clothing insulates firemen from the worst effects of external heat sources, it is heavy and the very nature of the clothing, for example use of vapor barrier materials, effectively inhibits the passage of heat away from the body.

Physical exertion causes fire-fighters to sweat. Aggravated by thermal stress from working in a hot environment, the body attempts to lose excess heat by directing blood flow to the skin. This reduces blood flow to vital organs, leads to dehydration, salt loss and increased heart rate. This phenomenon is known as heat stress and has symptoms which include fatigue, confusion, renal failure and eventually cardiac arrest.

Heat stress has been recognized for many years. That the symptoms of heat stress can be made more critical by the poor physical condition and weight of some fire-fighters is also well known. The demand for ever increasing levels of protection from external heat have further exacerbated the problem. As materials are developed that increase heat insulation fire-fighters have been forced to find new ways to sense ambient temperature on the fire ground. Previously it was common practice to keep the earlobes free of protective clothing or to cut a hole in the rear of the jacket in order to “feel” when temperatures became too extreme.

The efficiency of garments in insulating against external heat allows fire-fighters to spend greater time exposed to hazardous fire ground conditions. For example, better protective gear allows greater confidence in undertaking internal rescue work and fire suppression activity, and in turn, can allow greater time on site involved in the activity. Exposure times can increase and, in turn, heat stress may also become more apparent.

Evolving technology has brought advances in bunker gear which allows greater care of fire-fighters. For example, U.S. Pat. Nos. 5,635,909 and 5,973,602 disclose a system for temperature monitoring which may be incorporated into fire-fighting gear. One example of gear in which the system may be used includes turnout jackets or bunker coats. Cole also discloses that this system may be added to other fire equipment such as SCBA.

However, even with such advances, improvements are possible. For example, it is desirable to determine the ambient temperature at the body surface. Further, there is a need for visually displaying the sensed temperature, both from the exterior and interior surfaces of the gear at one location on the exterior surface of the gear.

As a result there is a need for further improvements in prior developments of this technology.

### SUMMARY OF THE INVENTION

In accordance with one aspect of the invention, there is provided a thermally insulative garment having an outer shell layer with an exterior side and an interior side, an inner thermal layer with an exterior side and an interior side, and a thermal detector system comprising at least two sensors, the first sensor positioned on the outer shell exterior side and the second sensor positioned on the inner thermal layer interior side, wherein the first and second sensors monitor variance in temperature and signal temperature change.

In accordance with a further aspect of the invention, there is provided a fire-fighter turnout coat comprising an outer flame retardant shell, an inner thermal insulating layer, and a thermal detector system comprising a first sensor positioned on the outer shell exterior side, the first sensor comprising a thermistor and a thermocouple, a second sensor positioned on the inner layer interior side and comprising a thermistor, a first display positioned adjacent the first sensor, and a second display positioned remotely from the first sensor, and a power supply.

The claimed invention provides thermally insulative garments of multiple layers having good ventilation and flexibility. The disclosed designs provide the flexibility for extended effective wear and protection in high risk environments such as fire-fighting. The claimed invention comes from recognized concerns that environmental extremes can result in stresses that must be guarded against. For example, with skin temperature, the difference between pain and second degree burns is a mere 54° F. Further, a temperature stressed fire-fighter consumes 30% to 40% more air reducing time on self-controlled breathing apparatus.

The TST-system/invention alerts fire-fighters when thermal stress factors reach critical levels. This system is designed to increase fire-fighters' awareness to the risk for heat stress and provide the security of a visual alert to abnormal/critical temperatures via a flashing L.E.D. array. Two independent heat sensors are required. A sensor located inside the fire-fighter's jacket measures developments in body temperature inside the protective clothing and a sensor located on the rear of the jacket alerts fire-fighters to dangerous external temperature increases behind them before these prohibit their withdrawal.

The disclosed temperature sensing system uses sensors encapsulated in silicone labels to register and alert fire-fighters to critical changes in external and internal garment temperatures. The design of the labels encapsulates sensors and visual displays while also including a conductive ribbon which acts as a “fabric wire” between the labels, the control unit and control circuits.

The invention includes an inner micro-electronic temperature sensor preferably placed inside the jacket together with the control unit. The sensor and control unit are connected to a display panel sewn onto the sleeve of the jacket and an external beat sensor preferably sewn onto the shoulder and which registers critical increases in ambient temperature. This sensor also has a display diode that is visible so that it may be seen by the wearer's partner. The external sensor is connected to the display on the sleeve and the battery box by a conductive textile ribbon which enables critical temperature increases to be displayed by means such as a light emitting diode.

The overall principle for temperature sensing with the thermal detector system of the invention is based on communication between the sensors, control unit and displays. The various functions of the system have different addresses and are all controlled by circuitry in the control unit. In principle, the control unit transmits different functions concerning status and compares the response with a predetermined program. The temperatures inside the turnout coat, for example, are measured by the inside temperature sensor and transmitted to the integrated circuit which determines whether the measured temperature lies within defined limits. If the measured temperature lies within the limits defined as safe, no further response is made. If the temperature measured by the sensor lies above a first or second limit, defined as unsafe, for example, the integrated circuit within the control unit communicates to the displays and the appropriate visual signal is sent. The sensing principle is based on the actual temperature inside the coat since the temperature deviation is expected to be relatively slow and low.

The temperature outside the fire-fighter's turnout coat is measured by the combination of external temperature, by for example, thermocouple, located in the shoulder label and by circuit board temperature sensor, for example, a thermistor, in the same label. The thermistor in the circuit board registers the exact temperature, and the thermocouple expresses a relative temperature. The external temperature is therefore always the product of both sensor measurements. This principle allows for the thermistor on the circuit board to register whether the circuit board is becoming overheated. The combination of two sensors also allows the operator to determine current external ambient temperature. Further, a sudden increase in difference between the two sensors indicates that the external ambient temperature is rising rapidly. This is a result of insulating the thermistor with the circuit board and exposing the thermocouple by gluing it to a metal plate on the surface of the label.

### BRIEF DESCRIPTION OF THE FIGURES

FIG. 1a is a front elevational view of a fire-fighter bunker coat in accordance with one preferred embodiment of the invention.

FIG. 1b is a rear perspective view showing one embodiment of the invention in its environment of use.

FIG. 2 is a schematic depiction of the thermal detector system used in the fire-fighter bunker coat illustrated in FIG. 1a.

FIGS. 3a through 3d are various depictions of the structure, properties and activity of a fabric which may be used as an outer shell layer in accordance with various embodiments of the invention.

FIG. 4 is a schematic depiction of the electrical circuit for the thermal detector system illustrated in FIG. 2.

FIG. 5a is a plan view of one embodiment of a conductive textile ribbon in accordance with one aspect of the invention.

FIG. 5b is a cutaway axial view of an exemplary conductive fibers used in the conductive textile ribbon depicted in FIG. 5a.

FIG. 6 is an exploded perspective view of one embodiment of a power source and control circuit in accordance with one aspect of the invention.

FIG. 7a is an exploded perspective view of one embodiment of a sensor and signal which may be used in accordance with the invention.

FIG. 7b is a top plan view of the sensor and signal depicted in FIG. 7a.

FIG. 8a is a further embodiment of a signal display which may be used in accordance with the invention illustrated in exploded perspective view.

FIG. 8b is a top plan view of the signal display depicted in FIG. 8a.

FIG. 9 is a graphical depiction of a representative exemplary profile showing response of the sensors to the ambient environment.

FIG. 10 is a schematic depiction of the self-test for activating the thermal detection system in accordance with the thermally insulative garment of the invention.

### DETAILED DESCRIPTION OF THE PREFERRED EMBODIMENTS

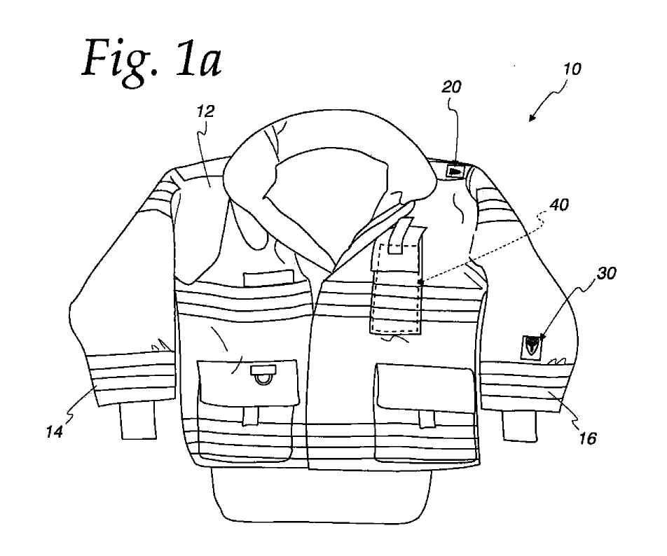

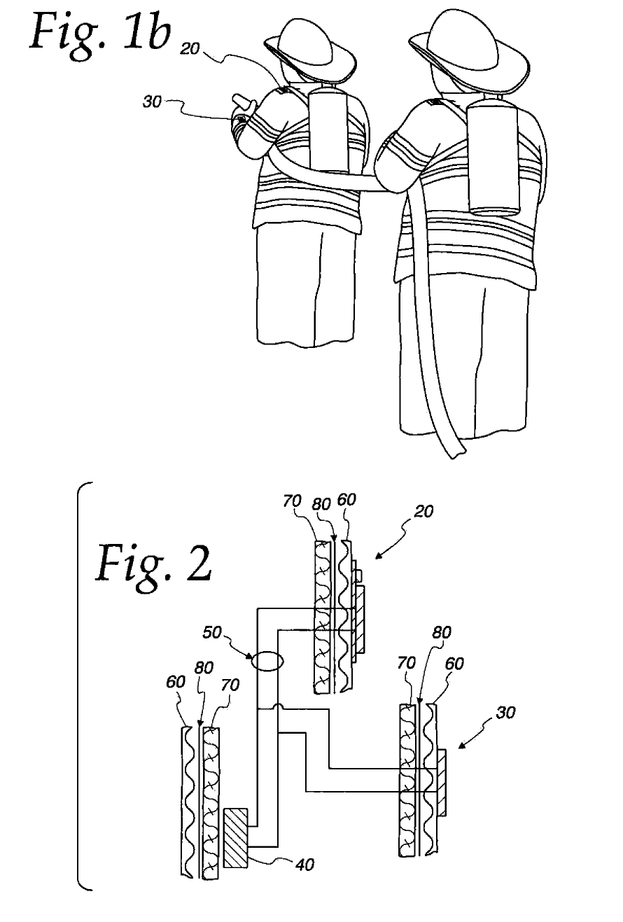

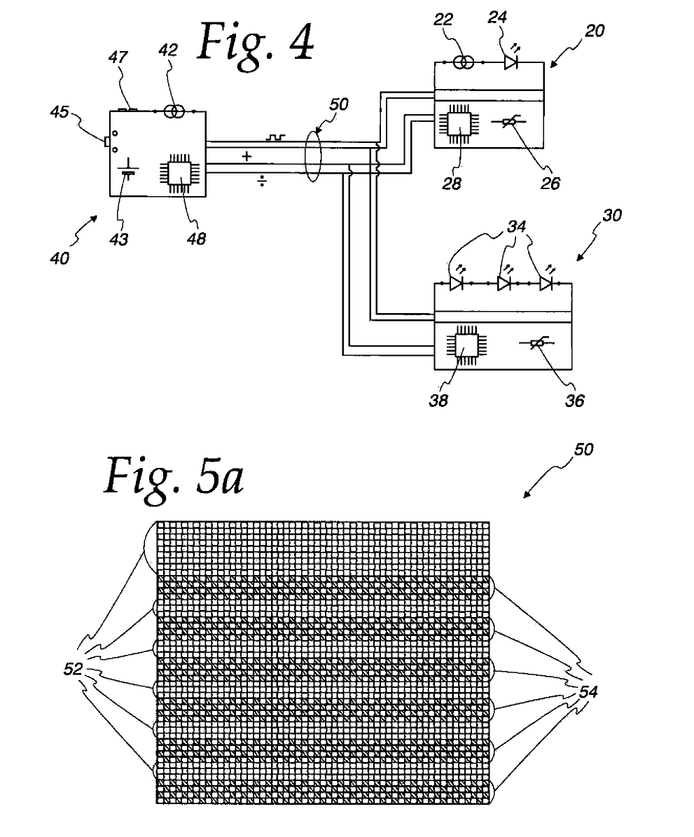

The invention will now be illustrated through several views wherein like parts are designated by like numerals throughout these several views. One aspect of the invention is a thermally insulative garment such as a fire-fighter's bunker or turnout coat 10, FIG. 1. The turnout coat 10 as seen in FIG. 1a generally comprises a body portion 12 with two arms 14, 16. As can be seen in FIG. 1a, the turnout coat may have one or more sensors and displays 20 and 30. Further, the turnout coat 10 in accordance with the invention generally has internal circuitry including a power source, control unit, and sensor 40 as well as interconnections 50 inside the jacket 10, FIGS. 2 and 4a.

While the invention may be used in any insulative garment, one principle application is fire-fighting gear. Fire-fighting gear, and in particular jackets 10, are typified by multilayer clothing. Typically, clothing of this type may have two or more layers. These layers may include an outer protective layer 60, an inner thermal insulating layer 70, and an optional intermediate third layer 80, such as a moisture barrier layer. Added intermediate layers may also be used depending on the ultimate application of the garment and the specifications of the user. The outer layer 60, FIG. 2, functions to protect the wearer against exposure from water, heat, and physical harm. The outer layer provides a physical shell and can be made from materials such as Nomex®, Kevlar® and other materials made from temperature and contact resistant synthetic fibers.

Synthetic fibers useful to this end include polymeric fibers having a monomeric composition including monomers selected from the group consisting of an ester, an ether, a ketone, an amide, a vinyl alcohol, a tetrafluoroethylene, a vinyl chloride, an imide, a sulfone, an olefin, a benzoxazole, an acetone, an acrylic, an acrylate, an acrylonitrile, an oxide, a sulfide, a phenylene, compounds thereof, compound mixtures thereof, polymers thereof, and polymer mixtures thereof. Commercial materials available for producing the outer shell layer 60 of the jacket include Nomex® Titan™, Nomex® Advance™, and Nomex® Advance Ultra™ all available from DuPont as well as PBI Gemini™ Matrix™, and Basofil® Gladiator™, among others.

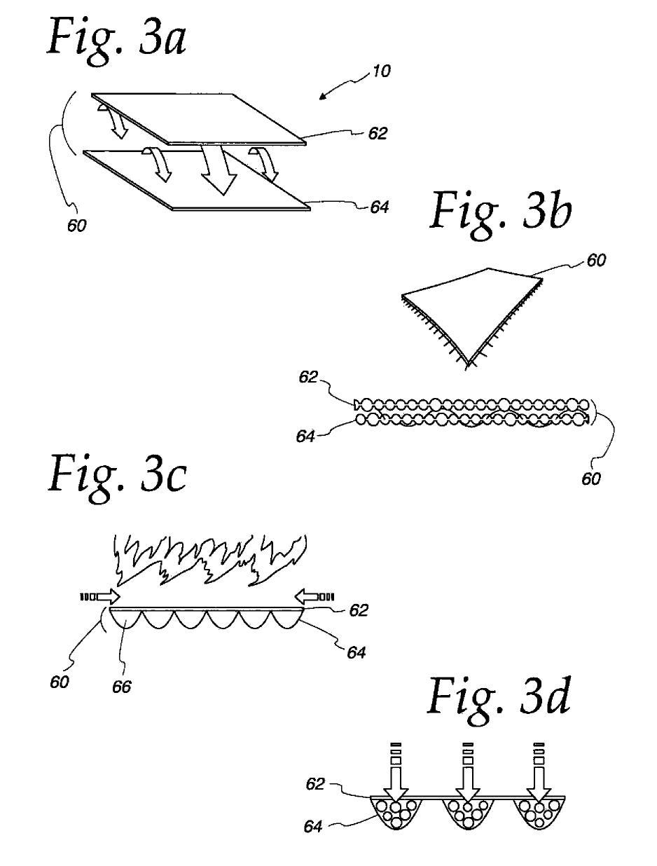

In one preferred embodiment of the invention, found at FIGS. 3a-3d, the outer shell 60 may be a dual layer comprising a first material which is highly susceptible to thermal condition, contracting with exposure to elevated temperature. This material comprises the outer surface of the shell layer. The second layer 64 comprises a material which has a lower susceptibility to increasing temperature when exposed to heat and doesn't expand or contract to the same degree as the first layer 62. These materials are chosen based upon not only their resistance to physical and thermal stress but also their differences in coefficients of thermal expansion.

First and second layers 62 and 64, respectively, are generally connected to make a bilayer through any variety of means, FIG. 3b, known to those of skill in the art. Important to the construction of the first and second layers 62, 64 of outer shell 60 is that when the bilayer 60 is subjected to increasing heat, outer layer 62 shrinks in relationship to inner layer 64 to form voids 66. Voids 66 from air pockets which provide added insulation against the external environment, FIGS. 3c and 3d. Generally voids begin to form with increasing temperatures over 100° c. and become fully formed at about 350° c. Preferred materials for use in the outer shell bilayer include an outer layer 62 of Nomex® and an inner layer 64 of the Kevlar® both available from DuPont.

In accordance with a further aspect of the invention, there is provided an interior thermal layer 70. Generally this thermal layer 70 functions to protect the wearer from temperature conditions external to the jacket 10. The thermal layer 70 may comprise any number of materials including batting, knits, spunlace, woven textiles, nonwoven textiles or any combinations thereof. Here again, Nomex® and Kevlar® fibers may be woven together in a single layer or in combination with fiber selected from those provided above.

Commercial materials useful as thermal layer 70 include ISOMEX® Iso'Air™ available from Duflot.

Further intermediate layers may be included in the garment in accordance with the invention. In one example, a moisture barrier layer 80, FIG. 2. The third layer 80, as seen in this embodiment, is used in the invention as a barrier against moisture. Moisture barrier 80 generally functions to preclude penetration of exterior moisture into the garment, including steam, organic and aqueous chemical fluids including water, and microbiological agents including bacterial and viral agents. Materials which are useful to this end include Crosstech™ and Gore™ RT 7100 both available from Gore Industries.

In further detail as can be seen in FIG. 2, the invention comprises one or more sensors and displays. This element functions to sense ambient temperature outside of the jacket, report the sensed temperature and transmit signals through visual display. A first sensor and display 20 may be located on the jacket 10 shoulder as seen in FIG. 1b. In one embodiment of the invention, the first sensor and display 20 may be mounted on the upper rear shoulder of the jacket, FIG. 1b. This allows a following fire-fighter to see the illuminated display as personnel move through hazardous environments. This display may be mounted or woven into the fabric of the jacket by any means known to those of skill in the art.

A second display 30 may be woven on the external portion of the jacket 10, again as seen in FIGS. 1a/1b and 2. In this instance, the display is remote from the first display 20 being located on the jacket arm 16. In accordance with this embodiment of the invention, both displays are wired to the control unit 40 which comprises an internal sensor and power source, FIG. 2.

One principle benefit of the invention is that the first display/sensor 20 is mounted on the exterior surface of the jacket while the second sensor is located in the interior surface of the jacket as part of control circuit 40 and directly adjacent the wearer, FIG. 2.

In accordance with one aspect of the invention, garments are provided which have at least two sensors. One sensor is placed on the outside of the garment to measure external ambient temperature. A further sensor is placed on the far interior of the garment, adjacent the wearer. The sensors are interconnected by means such as electrical wiring or radio control. At least three temperatures (absolute and relative) are sensed, the external ambient temperature, the internal ambient temperature, and the difference between internal and external temperatures. These temperatures may be used to activate any number of signals in accordance with the invention. Further, any number of different sensors may be used as one of skill in the art will know having read this specification in accordance with the invention.

Exemplary electronics of the thermal detection system of the invention are further depicted in FIG. 4 as can be seen. The first sensor/display 20 may take any number of different forms in accordance with the invention. In accordance with one embodiment of the invention, the first sensor/display 20 may comprise a display such as a light emitting diode 24, means for converting sensed heat into an electronic signal such as a thermistor 26 and an integrated circuit 28 which will control communication of the sensed temperature through current flow 22 to the control unit 40 and in turn transmission of an electronic signal to the light emitting diode 24 for purposes of providing a visual indication of temperature. As earlier disclosed, this first sensor 22 may also comprise a thermocouple.

Similarly, the second device 30 may be a personal display and generally comprises means for indicating variance in temperature such as one or more light emitting diodes 34. Second signal means may also comprise a thermistor 36 for assisting in sensing heat and communicating these signals and an integrated circuit for purposes of communicating with the control unit 40. Optionally or additionally, device 30 may also comprise a further sensor such as that contained in device 20, for sensing external ambient temperature.

The control unit 40 generally comprises a second temperature sensor and an integrated circuit for communication and translation of temperatures through current flow 42 to the first and second signals, 24 and 34. The control unit 40 also generally comprises a power source such as a battery 43 used to run the thermal detector system of the invention.

Various safeguards may also be placed into the control unit 40 including a self-test as indicated by self-test button 45 and debugging terminals 47 which may be used to program or reprogram the thermal detector system of the invention.

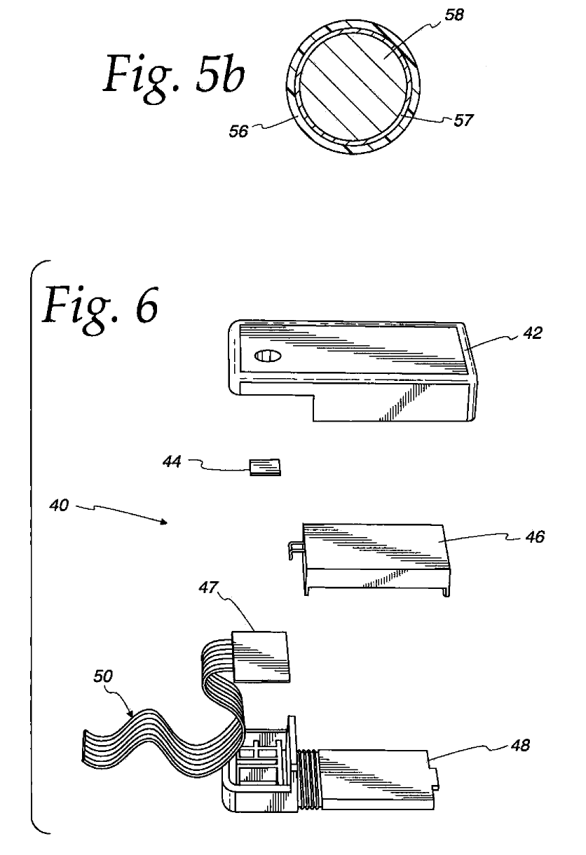

The interconnection 50 shown in FIG. 4 may be made of conductive ribbon, FIG. 5(a). One type of conductive ribbon found useful in accordance with the invention is that made of Nomex® yarn (SYN N-323 NM100/2 100% available from DuPont). In one specific instance yarn of the diameter of 400 microns with an “s” twist has been found useful. In accordance with the invention, four undyed Nomex® yarn strands may be wrapped with metal filaments twisted around each Nomex® fiber.

As can be seen in FIG. 5(b), the metal filaments may generally comprise a thread having an outer insulating coating 56 of, for example, polyester which surrounds a conductive layer 57 such as silver and having an interior conductive thread base 58 of, for example, copper FIG. 5(b). The one embodiment that has been found useful has the polyester coating at 3 to 4.5 microns, the silver layer at 0.8 microns, and the copper thread at 40 microns. The conductivity provided by such a thread is 13.50 ohms per filament per meter with a current load/demand maxing out at 100 milliamps per filament. As can be seen in FIG. 5(a), conductive portions 52 are separated by insulating portions 54 in a ribbon thread matrix 50. In addition to the conductive ribbon 50, electrical interconnections may be completed by radio signal by means known to those of skill in the art.

The control unit 40 as seen in FIG. 6 functions to receive the signals from the sensors used in the thermal detection system. In turn, the control unit functions to send signals to the displays or labels positioned on the exterior on the coat so that there is a visual indication of a change in temperature.

The control unit 40 may take any number of different configurations or structures consistent with that function. One embodiment of the control unit which is useful in accordance with the invention may be seen in FIG. 6. In this depiction, a cover or top 42 generally made out of a hard material such as silicone or polymeric plastic is used along with a base 48 of similar material to contain active components of the control unit 40. For example, components which may be used in the control unit include a sensor plate 44, battery (not shown), battery holder 46, and circuit board 47. Consistent with the function of this structure and its various elements, components and elements may be used which are light weight, easily assembled, and resistant to physical and thermal stress.

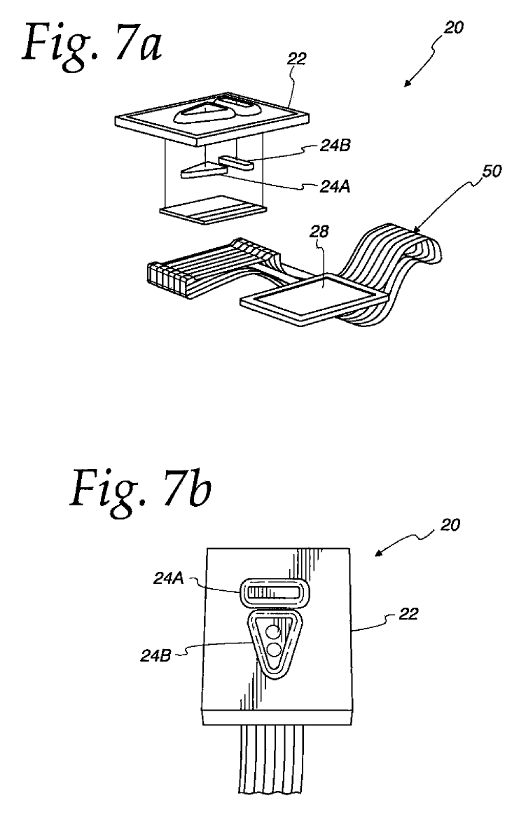

One embodiment of a combined sensor/display structure 20 is seen in FIGS. 7a and 7b. In this instance, textile wiring 50 is joined to the base structure 28 of the label into which a circuit board 26 rests. On top of the circuit board is mounted a sensor plate 24B and a translucent insert 24A, for example, an LED, which is used to signal the change in temperature. Over the top of the label 20 may be mounted a structure 22 made to protect the label from exposure to elements commonly found in the fire-fighting environment. The structure of the label top 22 and base 28 may be comprised of hard materials such as polymeric plastics or silicones, ceramics, etc. known to those of skill in the art which resist thermal degradation and contact stresses. A top plan view of this device 20 is depicted in FIG. 7b illustrating one design which the device may take in accordance with the invention.

As is explained further herein, sensor/display 20 preferably comprises two sensors. The first sensor preferably comprises a thermocouple which is directly attached to the metal base of the sensor/display 20. Further, sensor/display 20 also comprises a thermistor which is encapsulated within the circuit board of sensor/display 20. In accordance with the invention, the two different types sensors which are packaged differently on sensor/display 20, result in different sensed temperatures. The difference may be used to prompt alarms as noted below.

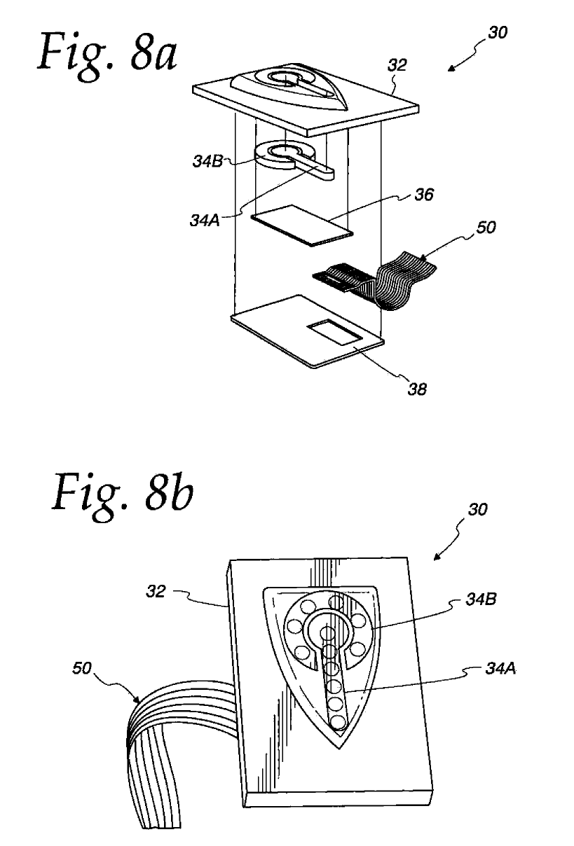

A further embodiment of a signal structure or label 30 may be seen in FIGS. 8a and 8b. In this embodiment, the label 30 serves exclusively as a display for signaling change in the thermal environment both externally and internally within the bunker coat 10. The structure of the signal or label 30 is similar to that shown in FIGS. 7a and 7b in that there is a base 38 which is covered by a label top 32, FIG. 8a. In between the base 38 and top 32 rests the fabric wiring, 50 the circuit board 36, and the translucent inserts 34a and 34b. In this particular embodiment, the inserts are set up to provide for light emitting diode type displays 34A and 34B known to those of skill in the art. For example, display 34A may provide a visual indication of temperature within the jacket that is in the interior of the thermal insulation 70 as provided by the second sensor 42 on control unit 40. In turn, visual display 34B may provide an indication of temperature in the environment which is external to the jacket as provided by sensor 22 as found on sensor/display 20.

The LED's may be configured to signal the users through any variety of patterns. For example, the LED's may be configured in series to alert the user together or in parallel to alert the user of separate events such as failing battery life, external temperature stress, or internal temperature stress.

Consistent with the labels shown in FIGS. 7a-7b and 8a-8b, where display element 24A may provide an indication of temperature in the external environment to the jacket, a system of signaling may be developed with the circuitry in the thermal detection system. For example, a fire-fighter could be warned of increasing temperature within the jacket internal environment by flashing of element 34A by one or more signals which are easy for the fire-fighter as well as his or her companions to visually detect. Additionally, increasing temperatures in the ambient external environment may be detected by the flashing of external elements 34B and 24A so as to signal the fire-fighters of dangerous conditions externally. Additional signals may be sent including indications of low battery power and malfunction including overheating of the circuit board in the environment of use.

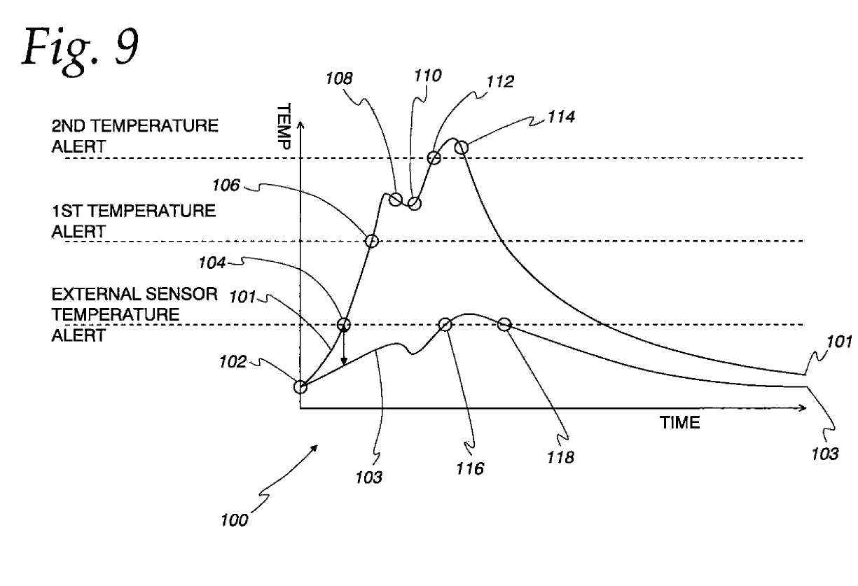

FIG. 9 depicts operation of one embodiment of the external thermal sensing system of the invention. Generally in a two sensor system any variety of thermal sensors may be used which are capable of sensing a variance in temperature and communicating that variance by way of electrical energy. The two sensors (internal and external) depicted in FIGS. 1 and 2 have similar function but, by their position, are exposed to very different environments of use.

Internal sensor 42, FIG. 4, is intended to have high sensitivity as it measures the temperature actually encountered by the wearer. In accordance with one preferred aspect of the invention, a thermistor may be used as the internal sensor. In turn, the external sensor 22, FIG. 4, is intended to respond reliably and accurately to large variations in temperature. Here again, in accordance with a preferred aspect of the invention, a thermocouple and thermistor may be used as the external sensor. As one of skill in the art will understand, the thermistor will provide a high degree of accurate sensitivity while the use of thermocouple provides predictable linear sensitivity and response to changes in temperature.

The thermal sensor system discussed herein may be modeled after any number of electrical systems which allow for two sensors and the positioning of these sensors in a manner which is consistent with the invention.

In accordance with one preferred embodiment of the invention, one scheme of operation for the external thermal sensor system of the invention may be seen in FIG. 9 comparing the thermocouple to the thermistor. In graph 100, both sensors start at the same temperature; FIG. 9 at 102. As the garment wearer is exposed to thermal stress, the profile of the thermocouple sensor 101, FIG. 1 at 20, moves away from the profile of the thermistor sensor, FIG. 9 at 103. In at least this instance, profile is temperature measured over time.

At an arbitrary time, chosen by the operator or programmer, when the difference between profile 101 and 103 is determined to be too great, an alarm may be triggered at point 104 indicating that the ambient temperature is rising rapidly. A slower increase in temperature may result in a visual alarm at, for example, a higher temperature, FIG. 9 at 106. Again the profile used measures temperature (increasing and decreasing) over time.

A decrease in ambient temperature (FIG. 9 at 108) generally results in a reduction in the difference between sensed temperatures and cancellation of the visual alarm. Resurgence in the ambient temperature (FIG. 9 at 110) and, in turn, increase in difference between the sensed temperatures, results in the alarm being reactivated. As a result, it can be seen that the temperature alert may be activated, deactivated, and reactivated repeatedly depending upon ambient conditions.

Overall, this difference in temperature between the two sensors indicates that the ambient temperature is rising rapidly. This comes from insulating the thermistor within the sensor display unit 20 and exposing the thermocouple to at the surface of the unit by gluing it to the heat conductive metal plate of the unit.

The invention may also provide for a second temperature alert (FIG. 9 at 112). When the external temperature exceeds the second temperature alert, the control unit may be programmed to provide double the flash rate on the display. Added signals may also be used to show heightened temperature. Here again, with reduction in temperature, the signals may be programmed to deactivate or otherwise canceled.

At the same time that external temperature is being monitored, increase in thermistor temperature (FIG. 2 at 116), may also be monitored and signaled by, for example, signal 30 at 34A and 34B, FIG. 8b. The signal may be used to warn the fire-fighter that temperatures are exceeding pre set limits. Here again, receding temperature may be used to cancel the alerts (FIG. 9 at 118). Any number of software programs may be used to operate the sensors, signals and control systems in accordance with the invention. One program found useful includes I²C, a Multi-Master Serial Computer bus available from Philips.

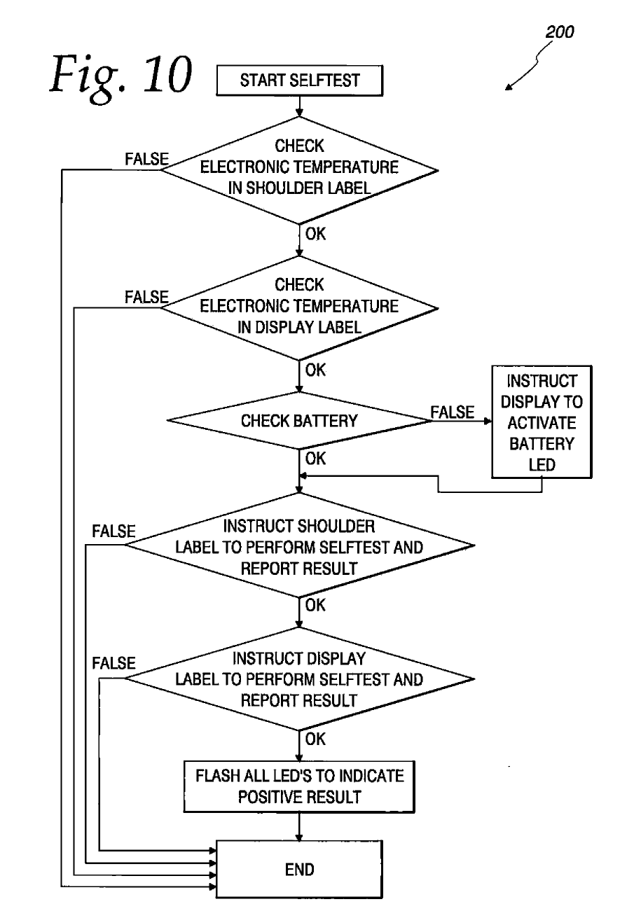

One further aspect of the invention is the ability to self-test the unit prior to use whether done periodically or prior to the arrival of an incident scene. This can be seen in FIG. 10, the control unit may comprise circuitry and programming which includes a self-test. The operator may merely initiate the self-test through the use of certain cues on the control unit. In doing so the operator checks the electronic temperature in the shoulder label to determine whether or not it is acceptable. If this is determined adequate, the display label self-test is initiated. The self-test is completed by the flashing of all L.E.D.'s to signal full operability. If any of the steps provide false readings or otherwise do not read to indicate an appropriate response, the test may be halted and restarted once the portion of the thermal detective system is replaced.

Although the present invention has been described in detail by way of illustration and example, it should be understood that a wide range of changes and modifications can be made to the preferred embodiments described above without departing from the scope and spirit of the invention. Thus, the described embodiments are to be considered in all respects only as illustrative and not restrictive, and the scope of the invention is, therefor, indicated by the appended claims rather than the foregoing description. All changes that come within the meaning and range of equivalency of the claims are to be embraced within their scope.

The claimed invention is:

1. A thermally insulative garment, said garment comprising:
(a) an outer shell layer having an exterior and an interior side;
(b) an inner thermal layer having an exterior and an interior side; and
(c) a thermal detector systems said thermal detector system comprising at least two sensors, said first sensor positioned on said outer shell exterior side and said second sensor positioned on said inner thermal layer interior side, wherein said first and second sensors monitor variance in temperature and signal temperature change.

2. The garment of claim 1, wherein temperature change is signaled by visual display.

3. The garment of claim 1, wherein said garment comprises a coat.

4. The garment of claim 1, wherein said garment comprises a fire-fighter turnout coat.

5. The garment of claim 4, wherein said outer shell layer comprises material selected from the group consisting of an abrasion resistant material, a flame resistant material, a heat resistant material, and combinations thereof.

6. The garment of claim 5, wherein said outer shell layer comprises a fiber based material, said fibers selected from the group consisting of aramid fibers, polybenzamidazole fibers, polyamide imide fibers, polyimide fibers, phenolic fibers, ceramic fibers, glass fibers, and mixtures thereof.

7. The garment of claim 4, wherein said thermal layer comprises thermal insulation.

8. The garment of claim 7, wherein said thermal insulation is selected from the group consisting of batting, knit, spunlace, woven textile, nonwoven textile, and mixtures thereof.

9. The garment of claim 7, wherein said thermal insulation comprises fibers selected from the group consisting of a natural fiber, a synthetic fiber, and mixtures thereof.

10. The garment of claim 9, wherein said natural fiber is selected from the group consisting of cotton, cellulose, wool, glass, and mixtures thereof.

11. The garment of claim 9, wherein said synthetic fiber comprises a monomer selected from the group consisting of an ester, an ether, a ketone, an amide, a vinyl alcohol, a tetrafluoroethylene, a vinyl chloride, an imide, a sulfone, an olefin, a benzoxazole, an acetone, an acrylic, an acrylate, an acrylonitrile, an oxide, a sulfide, a phenylene, compounds thereof, compound mixtures thereof, polymers thereof, and polymer mixtures thereof.

12. The garment of claim 4, wherein said outer shell layer comprises at least a first material and a second material, wherein said first material and said second material are affixed to each other in a manner which creates the formation of void spaces between said first and second materials when the garment is exposed to increasing temperature.

13. The garment of claim 12, wherein said first material comprises Nomex® and said second material comprises Kevlar®.

14. The garment of claim 12, wherein said first and second material comprise a dual layer, said first and second materials woven together in a manner which allows for portions of said first material to be unattached to portions of said second material.

15. The garment of claim 14, wherein the void spaces are formed between the unattached portions of said first and second materials.

16. The garment of claim 1, wherein there is a moisture barrier layer positioned between said outer shell and said inner thermal layer.

17. The garment of claim 1, wherein said garment comprises a fire-fighter turnout coat and said thermal detector system comprises a first sensor and a second sensor:
(a) said first sensor comprising a heat sensor positioned on said outer shell exterior side of said turnout coat, a first display positioned adjacent said first heat sensor, and a second display positioned remotely from said first sensor;
(b) said second sensor comprising a heat sensor positioned on inner thermal layer interior side;
(c) a power supply, wherein said first and second sensors and said first and second displays are electrically interconnected to communicate temperature change by said first and second displays.

18. The garment of claim 17, wherein said first sensor comprises an external temperature sensor and an integrated circuit, said integrated circuit controlling communication between said first sensor and said first display.

19. The garment of claim 17, wherein said first display comprises one or more light emitting diodes, said first display located adjacent said first sensor.

20. The garment of claim 17, wherein said second display comprises one or more light emitting diodes.

21. The garment of claim 17, wherein said second sensor comprises an internal temperature sensor and an integrated circuit.

22. The garment of claim 17, wherein said first sensor comprises a thermocouple and a thermistor and the temperature sensored is the product of the temperatures measured by said thermocouple and thermistor.

23. A fire-fighter turnout coat comprising:
(a) a flame retardant shell first layer having an exterior side;
(b) a thermal insulating second layer having an internal side; and
(c) a thermal detector system, said thermal detector system comprising,
(i) a first sensor positioned on said first layer exterior side, said first sensor comprising a thermistor and a thermocouple,
(ii) a second sensor positioned on said second layer interior side and comprising a thermistor,
(iii) a first display positioned adjacent said first sensor,
(iv) a second display positioned remotely from said first sensor, and
(v) a power supply.

24. The garment of claim 23, wherein said outer shell layer comprises a fiber based material, said fibers selected from the group consisting of aramid fibers, polybenzamidazole fibers, and mixtures thereof.

25. The garment of claim 23, wherein said thermal layer comprises thermal insulation selected from the group consisting of batting, knit, spunlace, woven textile, nonwoven textile, and mixtures thereof.

26. The garment of claim 23, wherein said thermal insulation comprises natural fibers, wherein said natural fibers are selected from the group consisting of cotton, cellulose, wool, glass, and mixtures thereof.

27. The garment of claim 23, wherein said thermal insulation comprises synthetic fibers, wherein said synthetic fibers comprises a monomer selected from the group consisting of an ester, an ether, a ketone, an amide, a vinyl alcohol, a tetrafluoroethylene, a vinyl chloride, an imide, a sulfone, an olefin, a benzoxazole, an acetone, an acrylic, an acrylate, an acrylonitrile, an oxide, a sulfide, a phenylene, compounds thereof, compound mixtures thereof, polymers thereof, and polymer mixtures thereof.

28. The turnout coat of claim 23, wherein said first and second sensors, said first and second displays, and said power supply are electrically interconnected by a conductive textile ribbon.

29. The turnout coat of claim 23, wherein said second display comprises an internal sensor display and an external sensor display.

30. The garment of claim 23, wherein said first sensor comprises an external temperature sensor and an integrated circuit, said integrated circuit controlling communication between said first sensor and said first display, said first display comprising one or more light emitting diodes, said first display located adjacent said first sensor and said second display comprises one or more light emitting diodes and an internal temperature sensor and an integrated circuit.

31. The garment of claim 23, wherein there is a moisture barrier layer positioned between said outer shell and said inner thermal layer.

32. A fire-fighter turnout coat comprising:
(a) an outer flame retardant shell having exterior and interior sides wherein said shell layer comprises a dual layer of first and second materials woven together in a manner which allows the formation of void spaces between said first and second materials when said turnout coat is exposed to increasing heat said first material comprising polyparaphenylene isophthalamide meta-aramid polymer and said second material comprising a para-aramid polymer;
(b) a second inner thermal insulating layer having an interior side, said second inner thermal insulating layer comprising a woven or nonwoven material;
(c) a moisture barrier layer positioned between said outer shell and said inner insulating layer;
(d) a thermal detector system, said thermal detector system comprising,
(i) a first heat sensor positioned on said shell exterior side, said first sensor comprising a thermistor and a thermocouple,
(ii) a second heat sensor positioned on said thermal layer interior side and comprising a thermistor,
(iii) a first display positioned adjacent said first sensor on said shell layer exterior side,
(iv) a second display positioned remotely from said first sensor on said shell layer exterior side, and
(v) a power supply, wherein said first and second sensors and said first and second displays are electrically interconnected with said power supply to communicate temperature change by light emission from said first and second displays, wherein said electrical interconnection comprises conductive textile ribbon.
